(19) United States
(12) Patent Application Publication
(10) Pub. No.: US 2025/0392962 A1
(43) Pub. Date: Dec. 25, 2025

(54) SYSTEMS AND METHODS FOR DETECTING ANCHOR OVERSHOOT FOR A FIXED WIRELESS ACCESS DEVICE

(71) Applicant: Verizon Patent and Licensing Inc., Basking Ridge, NJ (US)

(72) Inventors: Seng GAN, Ashburn, VA (US); Saibaba ATTELLI, Chalfont, PA (US); Anand BHATIA, Flower Mound, TX (US); Muhammad IBRAHEEM, Cypress, TX (US)

(73) Assignee: Verizon Patent and Licensing Inc., Basking Ridge, NJ (US)

(21) Appl. No.: 18/748,580

(22) Filed: Jun. 20, 2024

(51) Int. Cl. H04W 28/18; H04W 24/08

(52) U.S. Cl. CPC H04W 28/18; H04W 24/08

(57) ABSTRACT

A device may determine one or more base stations of a coverage area, and may determine one or more fixed wireless access (FWA) device identifiers in the coverage area. The device may identify a portion of the one or more FWA device identifiers not connected to any of the one or more base stations, as anchor overshoot FWA device identifiers, and may perform one or more actions based on the anchor overshoot FWA device identifiers.

### BACKGROUND

A fixed wireless access (FWA) device (e.g., customer premises equipment (CPE)) may connect to a fourth-generation (4G) base station (e.g., an eNodeB or eNB) and/or a fifth-generation (5G) base station (e.g., a gNodeB or gNB).

### BRIEF DESCRIPTION OF THE DRAWINGS

FIGS. 1A-1I are diagrams of an example associated with detecting anchor overshoot for an FWA device.

FIG. 2 is a diagram of an example environment in which systems and/or methods described herein may be implemented.

FIG. 3 is a diagram of example components of one or more devices of FIG. 2.

FIG. 4 is a flowchart of an example process for detecting anchor overshoot for an FWA device.

### DETAILED DESCRIPTION OF EXAMPLE EMBODIMENTS

The following detailed description of example implementations refers to the accompanying drawings. The same reference numbers in different drawings may identify the same or similar elements.

FWA devices are typically expected to connect to a nearest base station (e.g., a 4G base station or a 5G base station) so as to optimize signal strength, network resources, and, consequently, user experience. However, FWA devices may sometimes connect to a distant base station rather than to a neighboring base station resulting in a suboptimal configuration. This phenomenon, often referred to as “anchor overshoot,” can occur due to a variety of reasons, such as better line of sight due to topographical elevation, better antenna angles, or stronger transmit power from the distant base station. In the 4G/5G context, frequency reuse patterns, and particularly the reuse of physical cell identifiers (PCIs), may further complicate anchor overshoot. PCIs serve as unique identifiers for differentiating base stations operating on a same frequency band. When an FWA device erroneously connects to a distant base station, potential PCI confusion can arise, leading to significant performance and network management challenges. Thus, current techniques for connecting FWA devices and base stations consume computing resources (e.g., processing resources, memory resources, communication resources, and/or the like), networking resources, and/or other resources associated with handling anchor overshoot issues, causing network inefficiencies and connectivity issues due to anchor overshoot, causing a poor user experience for a user of an FWA device due to anchor overshoot, identifying occurrences of anchor overshoots, rectifying and verifying resolutions of such occurrences, and/or the like.

Some implementations described herein provide an overshoot detection system that detects anchor overshoot for an FWA device. For example, the overshoot detection system may determine base stations of a coverage area, and may determine FWA device identifiers in the coverage area. The overshoot detection system may identify anchor overshoot FWA device identifiers by determining which of the FWA device identifiers are not connected to one of the base stations in the coverage area. Once the overshoot identifiers are determined, one or more actions may be performed.

In this way, the overshoot detection system detects and resolves anchor overshoot issues in mobile networks using FWA devices. For example, the overshoot detection system may determine a list of base stations for a coverage area and may identify FWA device identifiers located in the coverage area. The overshoot detection system may create a list of FWA device identifiers that are not connected to nearest base stations, indicative of anchor overshoots, and may perform specific actions based on this list to optimize network connectivity and performance. The actions performed by the overshoot detection system may include recommending and/or adjusting antenna parameters (e.g., tilt, angle, or transmit power) of base stations, to ensure that FWA devices connect to intended neighboring base stations rather than distant base stations, as well as highlighting anchor overshoot occurrences on a map for visual representation. Thus, the overshoot detection system may conserve computing resources, networking resources, and/or other resources that would have otherwise been consumed by handling anchor overshoot issues, causing network inefficiencies and connectivity issues due to anchor overshoot, causing a poor user experience for a user of an FWA device due to anchor overshoot, identifying the occurrences of anchor overshoots, rectifying and verifying resolutions of such occurrences, and/or the like.

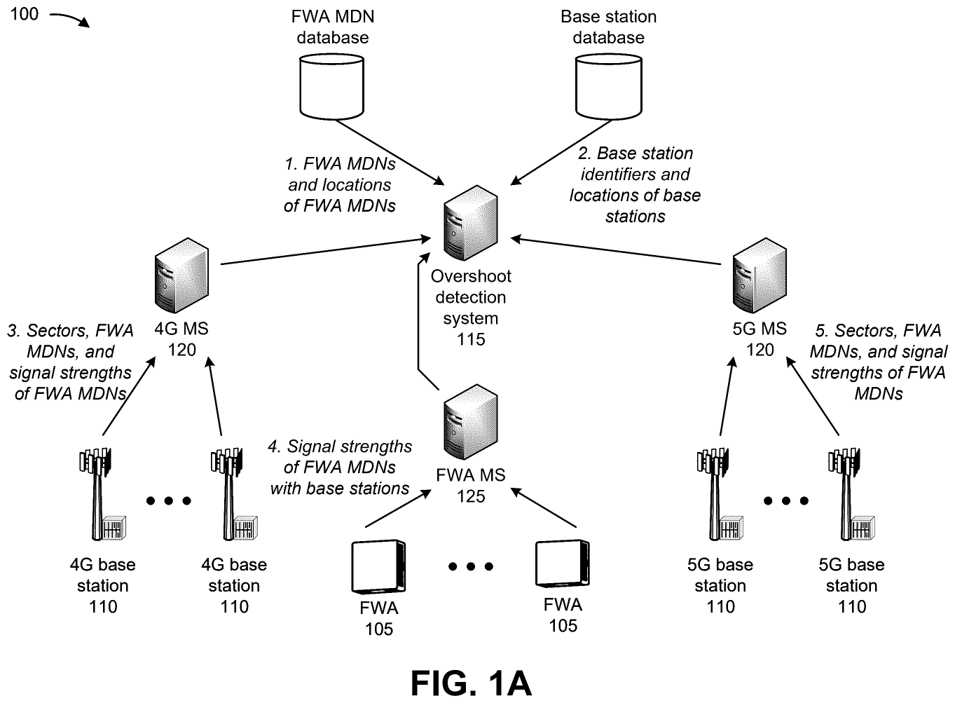

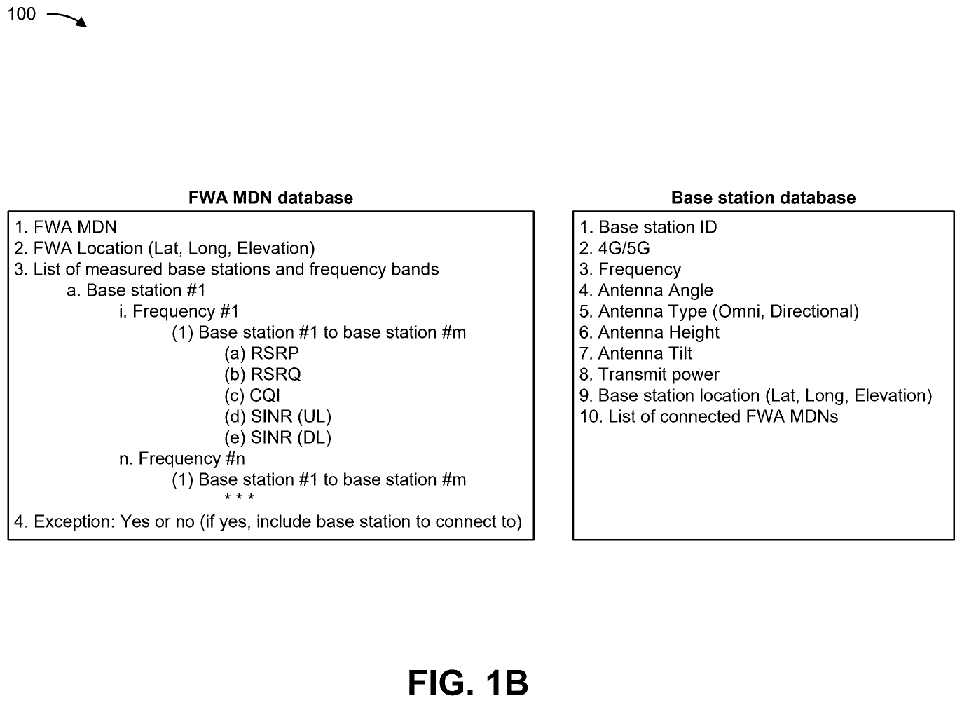

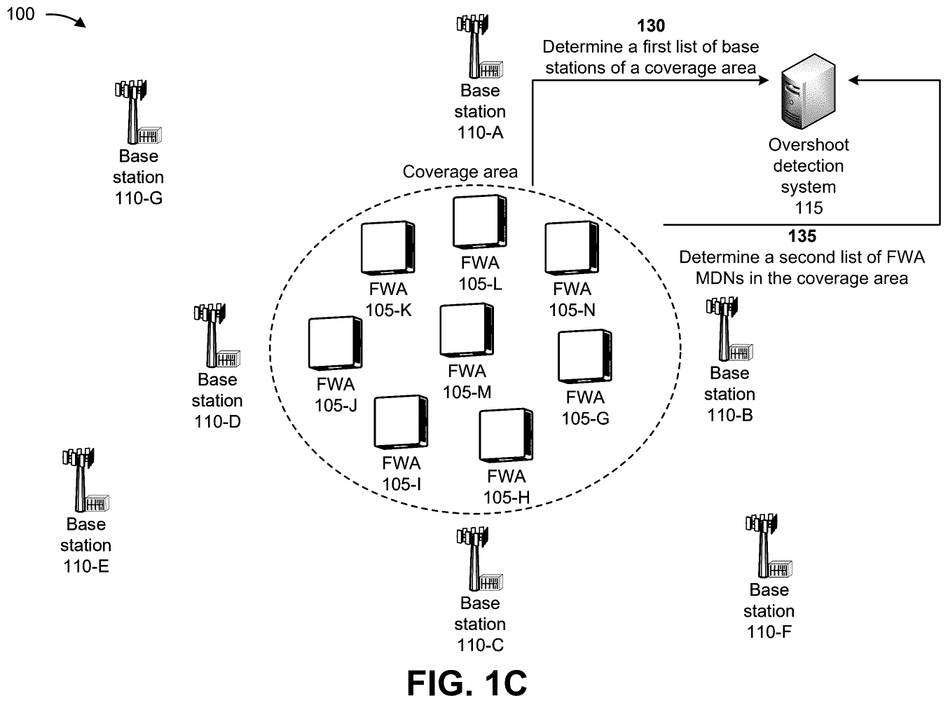

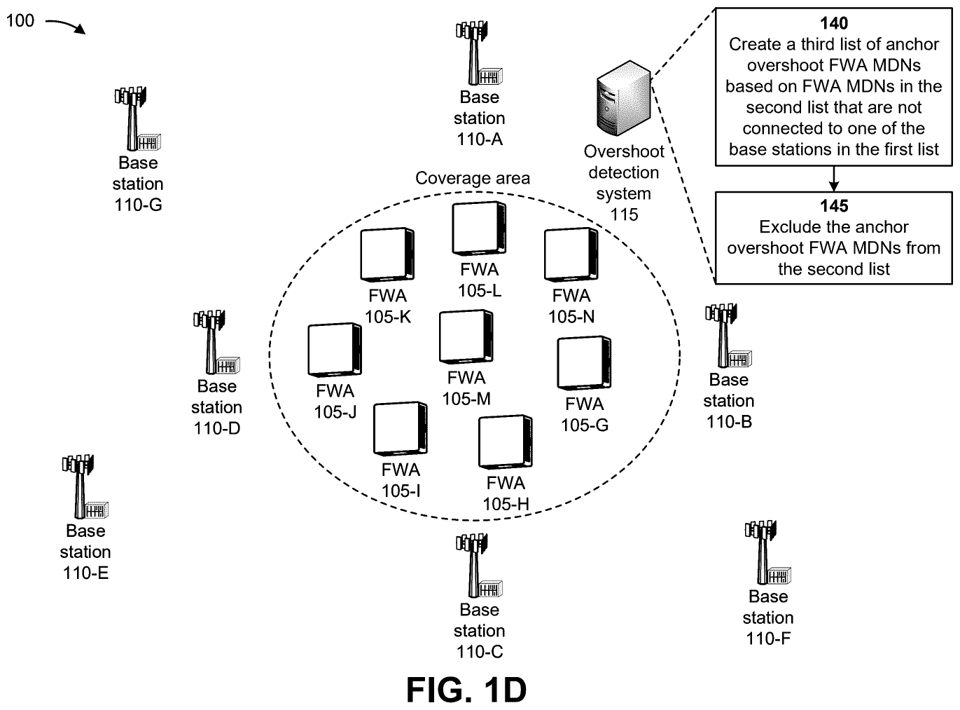

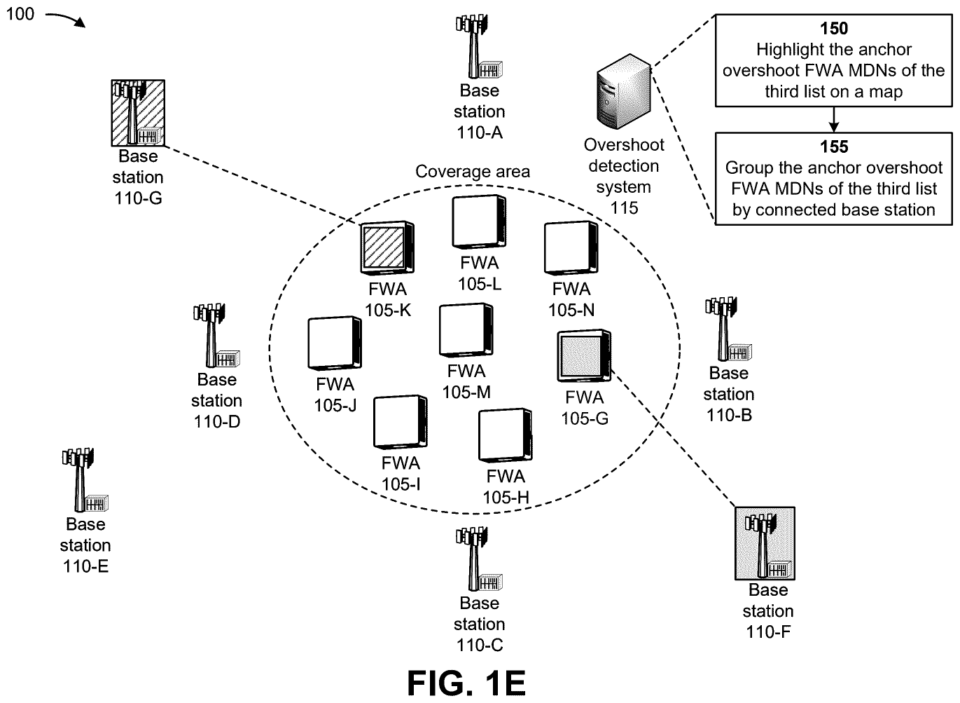

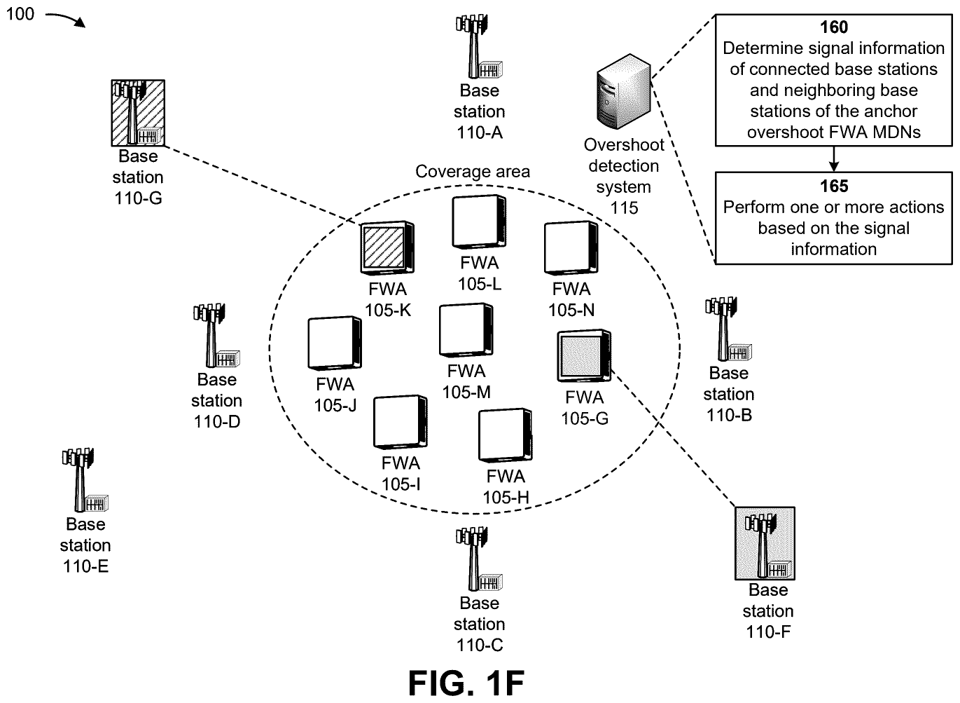

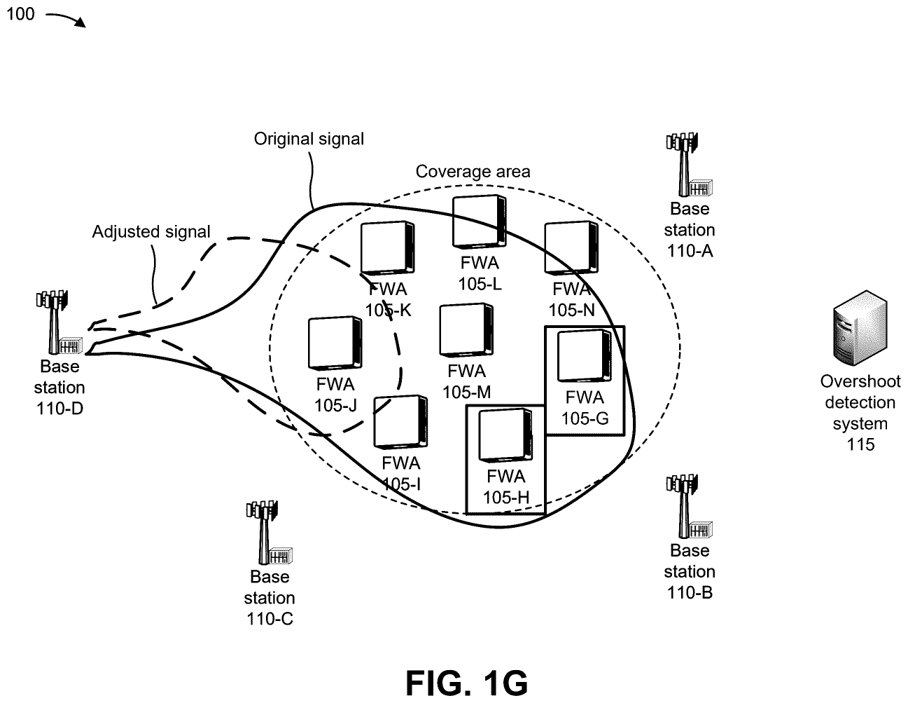

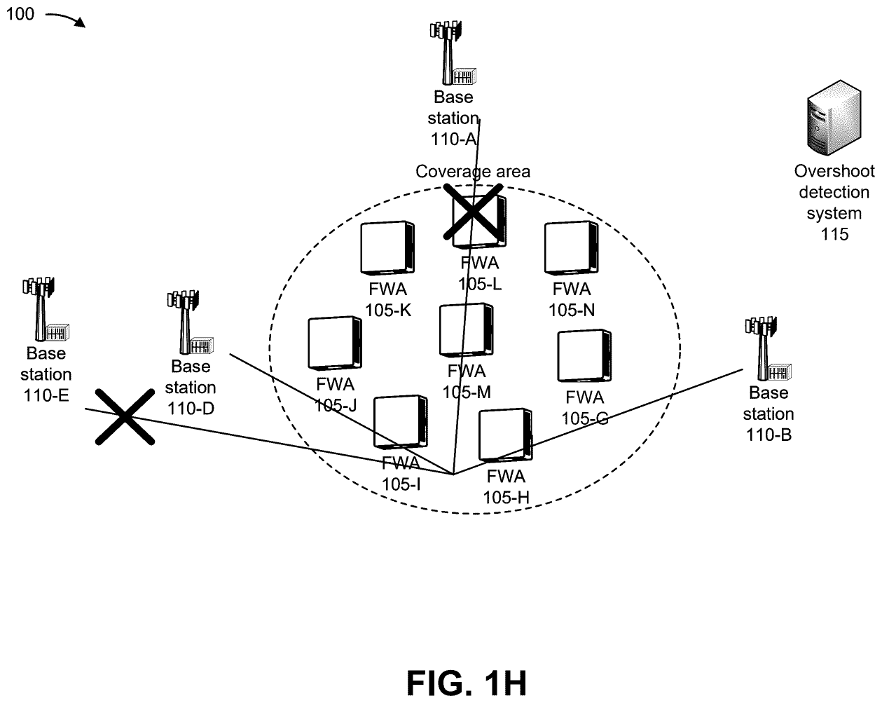

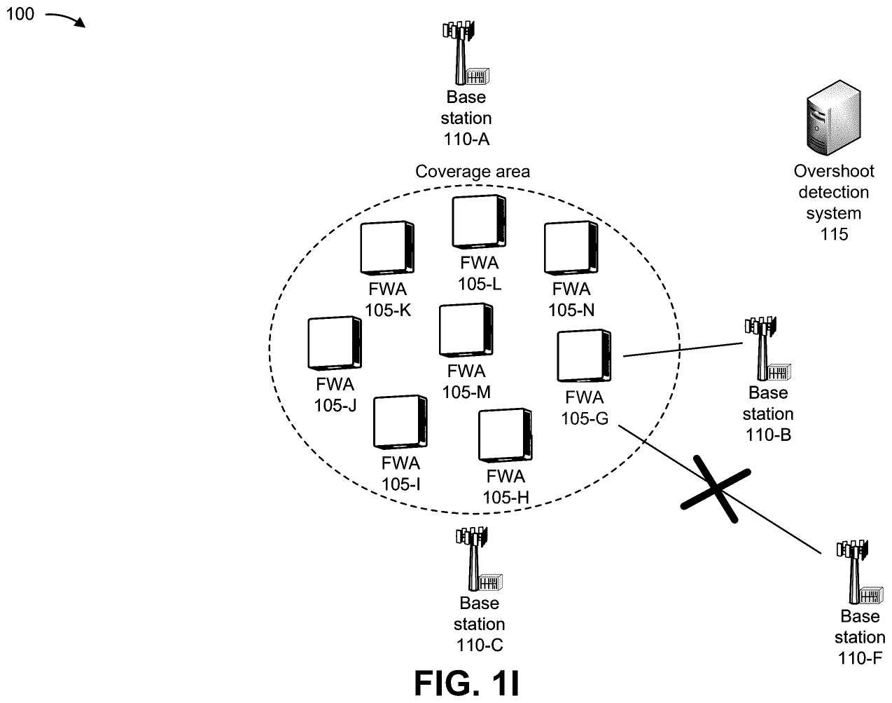

FIGS. 1A-1I are diagrams of an example 100 associated with detecting anchor overshoot for an FWA device. As shown in FIGS. 1A-1I, the example 100 includes FWA devices 105 associated with 5G base stations 110, 4G base stations 110, an overshoot detection system 115, and a plurality of data structures (e.g., databases, tables, lists, and/or the like), such as an FWA mobile directory number (MDN) database and a base station database. The example 100 also includes a 4G management system (MS) 120 associated with the 4G base stations 110, a 5G MS 120 associated with the 5G base stations 110, and an FWA MS 125 associated with the FWA devices 105. Further details of the FWA devices 105, the 4G base stations 110, the 5G base stations 110, the overshoot detection system 115, the FWA MDN database, the base station database, the 4G MS 120, the 5G MS 120, and the FWA MS 125 are provided elsewhere herein.

As shown in FIG. 1A, by reference number 1, the overshoot detection system 115 may receive FWA device identifiers (e.g., MDNs) and geographic locations of the FWA devices 105 (e.g., within the coverage area) from the FWA MDN database. The overshoot detection system 115 may periodically collect the FWA MDNs and the geographic locations of the FWA devices 105, and may store the FWA MDNs and the geographic locations of the FWA devices 105 in the FWA MDN database. As shown by reference number 2, the overshoot detection system 115 may receive base station identifiers and geographic locations of the base stations 110 from the base station database. The overshoot detection system 115 may periodically collect the base station identifiers and the geographic locations of the base stations 110, and may store the base station identifiers and the geographic locations of the base stations 110 in the base station database.

As further shown in FIG. 1A, and by reference number 3, the 4G MS 120 may periodically or continuously receive, from the 4G base stations 110, data identifying sectors of the 4G base stations 110, FWA MDNs associated with the 4G base stations 110, and signal strengths of the FWA devices 105 corresponding to the FWA MDNs associated with the 4G base stations 110. The 4G MS 120 may periodically or continuously provide, to the overshoot detection system 115, the data identifying the sectors of the 4G base stations 110, the FWA MDNs associated with the 4G base stations 110, and the signal strengths of the FWA devices 105 corresponding to the FWA MDNs associated with the 4G base stations 110.

As further shown in FIG. 1A, and by reference number 4, the FWA MS 125 may periodically or continuously receive, from the FWA devices 105, data identifying signal strengths of the FWA devices 105 with the base stations 110 (e.g., the 4G base stations 110 or the 5G base stations 110). The FWA MS 125 may periodically or continuously provide, to the overshoot detection system 115, the data identifying the signal strengths of the FWA devices 105 with the base stations 110.

As further shown in FIG. 1A, and by reference number 5, the 5G MS 120 may periodically or continuously receive, from the 5G base stations 110, data identifying sectors of the 5G base stations 110, FWA MDNs associated with the 5G base stations 110, and signal strengths of the FWA devices 105 corresponding to the FWA MDNs associated with the 5G base stations 110. The 5G MS 120 may periodically or continuously provide, to the overshoot detection system 115, the data identifying the sectors of the 5G base stations 110, the FWA MDNs associated with the 5G base stations 110, and the signal strengths of the FWA devices 105 corresponding to the FWA MDNs associated with the 5G base stations 110.

FIG. 1B depicts example data that may be stored in the FWA MDN database and the base station database. As shown, the FWA MDN database may include data identifying FWA MDNs (e.g., unique identifiers for FWA devices 105 within the coverage area); geographic locations (e.g., latitudes, longitudes, and elevations) of the FWA devices 105; measured base stations 110 associated with the FWA devices 105; frequency bands of the measured base stations 110; signal quality metrics for the measured base stations 110 relative to the frequency bands, such as a reference signal received power (RSRP), a reference signal received quality (RSRQ), a channel quality indicator (CQI), and a signal-to-interference-plus-noise ratio (SINR) for both uplink (UL) and downlink (DL) communications; and an exception field that indicates whether there is an exception to typical connectivity rules (e.g., and if so, indicates the base station 110 to which the FWA device 105 should connect); and/or the like.

As further shown in FIG. 1B, the base station data database may include data identifying base station identifiers (IDs) of the base stations 110; indications of whether the base stations 110 are 4G base stations or 5G base stations; frequency bands in which the base stations 110 operate; antenna angles of the base stations 110, antenna types (e.g., omnidirectional or directional) of the base stations 110; antenna heights of the base stations 110; antenna tilts of the base stations 110; transmit powers of the base stations 110; geographic locations (e.g., latitudes, longitudes, and elevations) of the base stations 110; connected FWA devices 105 connected to the base stations 110; and/or the like.

Together, the FWA MDN database and the base station database may enable the overshoot detection system 115 to detect and correct anchor overshoot situations by providing comprehensive data to identify the FWA devices 105 experiencing suboptimal connectivity due to being associated with distant base stations 110 as opposed to proximal neighbor base stations 110. By leveraging the fixed locations of the FWA devices 105, the FWA MDN database and the base station database may enable the overshoot detection system 115 to analyze and subsequently adjust base station parameters, such as transmit power levels and antenna configurations to optimize network coverage and resolve anchor overshoot issues. In some implementations, the FWA MDN database and the base station database may facilitate prioritization of corrective actions by the overshoot detection system 115 based on traffic volume in the coverage area and a quantity of FWA devices 105 affected by anchor overshoot.

As shown in FIGS. 1C-1F, a coverage area may be provided by base stations 110-A, 110-B, 110-C, and 110-D for a plurality of FWA devices 105 (e.g., FWA devices 105-G, 105-H, 105-I, 105-J, 105-K, 105-L, 105-M, and 105-N). Base stations 110-E, 110-F, and 110-G may not provide the coverage area for the plurality of FWA devices 105 since the base stations 110-E, 110-F, and 110-G may be remote (e.g., further than a threshold distance) from the plurality of FWA devices 105.

As further shown in FIG. 1C, and by reference number 130, the overshoot detection system 115 may determine a set of base stations 110 of the coverage area. For example, the overshoot detection system 115 may identify and compile data associated with the base stations 110, such as the base stations 110-A, 110-B, 110-C, and 110-D associated with the coverage area and/or the base stations 110-E, 110-F, and 110-G not associated with the coverage area. The overshoot detection system 115 may include identifiers of the base stations 110-A, 110-B, 110-C, and 110-D associated with the coverage area in the set of base stations. The overshoot detection system 115 may store the data associated with the base stations 110 in the base station database, and may retrieve the data from the base station database based on a request for the data. The data associated with the base stations 110 may include the data described above in connection with FIG. 1B (e.g., geographic locations of the base stations 110, signal quality indicators of the base stations 110, and/or the like).

As further shown in FIG. 1C, and by reference number 135, the overshoot detection system 115 may also determine a set of FWA device identifiers (e.g., MDNs), such as identifiers for the FWA devices 105-G, 105-H, 105-I, 105-J, 105-K, 105-L, 105-M, and 105-N provided within the coverage area. For example, the overshoot detection system 115 may include the FWA MDNs of the FWA devices 105-G, 105-H, 105-I, 105-J, 105-K, 105-L, 105-M, and 105-N in the second list. The overshoot detection system 115 may collect the FWA device identifiers, which may include MDNs, for the FWA devices 105, and may store the FWA device identifiers and other data associated with the FWA devices 105 in the FWA MDN database. The overshoot detection system 115 may retrieve the data from the FWA MDN database based on a request for the data. The FWA device identifiers and the other data associated with the FWA devices 105 may include the data described above in connection with FIG. 1B (e.g., MDNs of the FWA devices 105, geographic locations of the FWA devices 105, signal quality indicators of the FWA devices 105, and/or the like). The set of FWA device identifiers may enable the overshoot detection system 115 to analyze a connectivity state of the FWA devices 105 in relation to the base stations 110 associated with the coverage area.

The overshoot detection system 115 may identify and address potential connection issues known as anchor overshoot (e.g., where one or more FWA devices 105 may connect to distant base stations 110 outside an optimal coverage area) based on these identified base stations and FWA device identifiers. According to exemplary aspects, the identified neighboring base stations and the FWA device identifiers, may be stored in a first and second list, respectively. In this way, the overshoot detection system 115 may improve performance of the network and user experience by ensuring that the FWA devices 105 connect to their appropriate, neighboring base stations 110, and by avoiding unnecessary signal degradation, interference, and network resource mismanagement.

As shown in FIG. 1D, and by reference number 140, the overshoot detection system 115 may identify anchor overshoot FWA MDNs based on the previously identified FWA MDNs that are not connected to one of the previously identified base stations 110. For example, the overshoot detection system 115 may identify the FWA devices 105 that are connected to one of the base stations 110 in the first list (e.g., base stations 110-A, 110-B, 110-C, and 110-D). The overshoot detection system 115 may identify the FWA devices 105 that are not connected to one of the base stations 110 in the first list. The overshoot detection system 110 may determine that such FWA devices 105 are connected to distant base stations 110 (e.g., base stations 110-E, 110-F, and 110-G), rather than to geographically proximate and intended base stations 110 (e.g., base stations 110-A through 110-D) that provide the coverage area for a particular frequency band. The overshoot detection system 110 may classify the MDNs of the identified FWA devices 105 (e.g., not connected to one of base stations 110-A through 110-D) as anchor overshoot MDNs, and may include the anchor overshoot MDNs in the third list.

The identification of the anchor overshoot FWA devices 105 may enable the overshoot detection system 110 to provide network optimization and the maintenance of high-quality service. The identification of the anchor overshoot FWA devices 105 may enable the overshoot detection system 115 to pinpoint the FWA devices 105 that experience anchor overshoot, a condition where the FWA devices 105 are connected to base stations 110 outside of an optimal service range, which can lead to network inefficiencies and reduced performance.

As further shown in FIG. 1D, and by reference number 145, the overshoot detection system 115 may exclude the anchor overshoot FWA MDNs from the second list. For example, the overshoot detection system 115 may remove the FWA MDNs (e.g., included in the third list) from the FWA MDNs of the second list. Excluding the anchor overshoot FWA MDNs from the second list may remove the MDNs of the FWA devices 105 that are associated with suboptimal connections from the list of FWA devices 105 associated with optimal connections, which may enable the overshoot detection system 115 to refine the quality of service parameters and improve overall network management. By proactively removing the anchor overshoot FWA MDNs from the second list, the overshoot detection system 115 may optimize network resource allocation and may prioritize connections for the FWA devices 105 associated with the anchor overshoot FWA MDNs to more appropriate, neighboring base stations 110.

In some implementations, the overshoot detection system 115 may perform one or more actions based on the third list of anchor overshoot FWA MDNs. For example, the overshoot detection system 115 may exclude the anchor overshoot FWA MDNs from the second list, as described above in connection with FIG. 1D. In some implementations, performing the one or more actions may include the overshoot detection system 115 highlighting the anchor overshoot FWA MDNs of the third list on a user interface (e.g., a map), and providing the map for display to a user of the overshoot detection system 115. For example, the overshoot detection system 115 may highlight (e.g., via color coding, graphics, and/or the like) representations of the FWA devices 105 associated with the anchor overshoot FWA MDNs on the map, as described below in connection with FIG. 1E.

In some implementations, performing the one or more actions may include the overshoot detection system 115 determining signal information of connected base stations 110 and neighboring base stations 110 for the FWA devices 105 associated with the anchor overshoot FWA MDNs, and causing the signal information of the connected base stations 110 and the neighboring base stations 110 to be modified to prevent the FWA devices 105 associated with the anchor overshoot FWA MDNs from experiencing anchor overshoot. In some implementations, performing the one or more actions may include the overshoot detection system 115 identifying a connected base station 110 and a neighboring base station 110 for an FWA device 105 associated with one of the anchor overshoot FWA MDNs, and modifying at least one parameter of the connected base station 110 or the neighboring base station 110 to prevent anchor overshoot of the FWA device 105 associated with the one of the anchor overshoot FWA MDNs.

In some implementations, performing the one or more actions may include the overshoot detection system 115 identifying a connected base station 110 and a neighboring base station 110 for an FWA device 105 associated with one of the anchor overshoot FWA MDNs, and causing one or more antennas of the connected base station 110 or the neighboring base station 110 to be adjusted to prevent anchor overshoot of the FWA device 105 associated with the one of the anchor overshoot FWA MDNs. In some implementations, performing the one or more actions may include the overshoot detection system 115 identifying a connected base station 110 and a neighboring base station 110 for an FWA device 105 associated with one of the anchor overshoot FWA MDNs, and causing one or more antenna tilt angles of the connected base station 110 or the neighboring base station 110 to be adjusted to prevent anchor overshoot of the FWA device 105 associated with the one of the anchor overshoot FWA MDNs.

In some implementations, performing the one or more actions may include the overshoot detection system 115 identifying a connected base station 110 and a neighboring base station 110 for an FWA device 105 associated with one of the anchor overshoot FWA MDNs, and causing transmit power levels of the connected base station 110 or the neighboring base station 110 to be adjusted to prevent anchor overshoot of the FWA device 105 associated with the one of the anchor overshoot FWA MDNs. In some implementations, performing the one or more actions may include the overshoot detection system 115 providing the anchor overshoot FWA MDNs for display. In some implementations, the overshoot detection system 115 may prioritize the one or more actions based on a volume of traffic in the coverage area and a quantity of FWA devices 105 associated with the anchor overshoot FWA MDNs.

As shown in FIG. 1E, and by reference number 150, the overshoot detection system 115 may highlight the anchor overshoot FWA MDNs of the third list on a map. For example, the overshoot detection system 115 may generate a user interface that includes a map displaying representations of the FWA devices 105 in the coverage area, the base stations 110 associated with the coverage area (e.g., base stations 110-A through 110-D), and the base stations 110 not associated with the coverage area (e.g., base stations 110-E, 110-F, and 110-G). The overshoot detection system 115 may identify the FWA devices 105 associated with anchor overshoot conditions based on the FWA MDNs provided in the third list. For example, the overshoot detection system 115 may determine that the FWA devices 105-G and 105-K are associated with anchor overshoot conditions, where the FWA device 105-G is connected to the base station 110-F rather the geographically appropriate base station 110 (e.g., the base station 110-B) and the FWA device 105-K is connected to the base station 110-G rather than the geographically appropriate base station 110 (e.g., the base station 110-D). As shown in FIG. 1E, the overshoot detection system 115 may highlight the FWA devices 105-G and 105-K (e.g., with colors, patterns, and/or the like) on the map. The overshoot detection system 115 may provide the user interface with the map for display to a user of the overshoot detection system 115. In this way, the user may quickly visualize the FWA devices 105 associated with the anchor overshoot conditions.

As further shown in FIG. 1E, and by reference number 155, the overshoot detection system 115 may group the anchor overshoot FWA MDNs of the third list by connected base station 110. For example, as shown in FIG. 1E, the overshoot detection system 115 may group (e.g., via connector line) the FWA device 105-G with the connected base station 110-F and may highlight the connected base station 110-F similarly to the highlighting for the FWA device 105-G. The overshoot detection system 115 may group (e.g., via connector line) the FWA device 105-K with the connected base station 110-G and may highlight the connected base station 110-G similarly to the highlighting for the FWA device 105-K. Grouping the anchor overshoot FWA MDNs of the third list by connected base station 110 may enable a user of the overshoot detection system 115 to quickly visualize and analyze groups of the FWA devices 105 that are improperly connected to distant base stations 110 rather than to neighboring base stations 110. The overshoot detection system 115 may utilize the groups to adjust parameters for the improperly connected base stations 110 and/or the neighboring base stations 110, such as antenna tilt, transmit power levels, or other configuration settings to rectify the anchor overshoot conditions. This also may enable network engineers to efficiently troubleshoot and resolve anchor overshoot issues, thereby improving network performance and reliability.

As shown in FIG. 1F, and by reference number 160, the overshoot detection system 115 may determine signal information of connected base stations 110 and neighboring base stations 110 associated with the anchor overshoot FWA MDNs. For example, the overshoot detection system 115 may analyze the signal information of the base stations 110 connected to the FWA devices 105 associated with anchor overshoot FWA MDNs, and the signal information of the neighboring base stations 110 of the FWA devices 105 associated with anchor overshoot FWA MDNs. The signal information may include RSRPs, RSRQs, CQIs, uplink SINRs, downlink SINRs, and/or the like for the connected base stations 110 and the neighboring base stations 110. By analyzing the signal information, the overshoot detection system 110 may identify discrepancies in connectivity between the connected base stations 110 and the neighboring base stations 110, which may cause potential service degradation.

As further shown FIG. 1F, and by reference number 165, the overshoot detection system 115 may perform one or more actions based on the signal information. For example, the overshoot detection system 115 may cause the signal information of the connected base stations 110 and the neighboring base stations 110 to be modified to prevent the FWA devices 105 associated with the anchor overshoot FWA MDNs from experiencing anchor overshoot issues. In some implementations, the modification of the signal information may cause the FWA devices 105 associated with the anchor overshoot conditions to disconnect from the connected base stations 110 and to connect to the neighboring base stations 110, which may eliminate the anchor overshoot issues. The modification of the signal information may include altering antenna parameters of the connected base stations 110 and the neighboring base stations 110, such as tilt angles, directional orientation, or transmit power levels to recalibrate coverage and strengthen the connection of the FWA devices 105 with the neighboring base stations 110.

FIG. 1G depicts an example use case associated with utilizing the overshoot detection system 115. As shown, the coverage area may be provided by the base stations 110-A through 110-D and may include the FWA devices 105-G through 105-N. However, the base stations 110-A through 110-D may be geographically spaced differently from the FWA devices 105-G through 105-N. The overshoot detection system 115 may perform the steps described above in connection with FIGS. 1C-1F to identify a group of FWA MDNs associated with the FWA devices 105-G and 105-H experiencing anchor overshoot issues. For example, the overshoot detection system 115 may determine that the FWA devices 105-G and 105-H are receiving an original signal from the base station 110-D and that the original signal is creating anchor overshoot issues. The overshoot detection system 115 may compare the received signal strengths from the base station 110-D and the neighboring base station 110-B and may identify the locations of the FWA devices 105-G and 105-H.

Based on comparing the signal strengths, the overshoot detection system 115 may adjust the configuration of the base station 110-D (e.g., to generate the adjusted signal) and/or may adjust the configuration of the neighboring base station 110-B. The overshoot detection system 115 may again perform the steps described above in connection with FIGS. 1C-1F to verify that the FWA devices 105-G and 105-H are not experiencing anchor overshoot issues. If the FWA devices 105-G and 105-H are still experiencing anchor overshoot issues, the overshoot detection system 115 may further adjust the configuration of the base station 110-D and/or may further adjust the configuration of the neighboring base station 110-B until the anchor overshoot issues are resolved.

FIG. 1H depicts an example use case associated with utilizing the overshoot detection system 115. As shown, the coverage area may be provided by the base stations 110-A through 110-D and may include the FWA devices 105-G through 105-N. However, the base stations 110-A, 110-B, 110-D, and 110-E may be geographically spaced differently from the FWA devices 105-G through 105-N. The overshoot detection system 115 may perform the steps described above in connection with FIGS. 1C-1F to identify a group of FWA MDNs associated with the FWA devices 105-H and 105-I that are switching between base stations 110-A, 110-B, 110-D, and 110-E. For example, the FWA devices 110-H and 110-I may be receiving coverage from the base stations 110-A, 110-B, 110-D, and 110-E, and may be switching between these base stations 110, resulting in low throughput. The overshoot detection system 115 may compare the received signal strengths from the base stations 110-A, 110-B, 110-D, and 110-E and may identify the locations of the FWA devices 105-H and 105-I.

Based on comparing the signal strengths, the overshoot detection system 115 may create a list of top base stations 110 in the coverage area that are serving the FWA devices 105-H and 105-I. The overshoot detection system 115 may adjust the configurations of the base stations 110-A, 110-B, 110-D, and 110-E. The overshoot detection system 115 may again perform the steps described above in connection with FIGS. 1C-1F to verify that the FWA devices 110-H and 110-I are not switching between the base stations 110-A, 110-B, 110-D, and 110-E and that throughput is improved. If the FWA devices 105-H and 105-I are still experiencing throughput issues, the overshoot detection system 115 may further adjust the configurations of the base stations 110-A, 110-B, 110-D, and 110-E until the throughput issues improve or cease.

FIG. 1I depicts an example use case associated with utilizing the overshoot detection system 115. As shown, the coverage area may be provided by the base stations 110-A through 110-D and may include the FWA devices 105-G through 105-N. However, the base stations 110-A, 110-B, 110-C, and 110-F may be geographically spaced differently from the FWA devices 105-G through 105-N. The overshoot detection system 115 may perform the steps described above in connection with FIGS. 1C-1F to identify an FWA MDN associated with the FWA device 105-G that is anchored to the base station 110-F and is failing to connect. The overshoot detection system 115 may compare the locations of the base stations 110-A, 110-B, 110-C, and 110-F and the location of the FWA device 110-G, and may create a list of base stations 110 that are located more than a predetermined distance from the FWA device 110-G based on the comparison. For example, the overshoot detection system 115 may determine that the base station 110-F is located more than the predetermined distance from the FWA device 110-G.

The overshoot detection system 115 may remove the base station 110-F from the list of potential anchors for the FWA device 110-G. The overshoot detection system 115 may once again perform the steps described above in connection with FIGS. 1C-1F to verify that the FWA device 110-G is not anchored to the base station 110-F and is failing to connect. If the FWA device 105-G is still anchored to the base station 110-F, the overshoot detection system 115 may adjust the configuration of the base station 110-F until the FWA device 105-G stops anchoring to the base station 110-F.

In this way, the overshoot detection system 115 detects and resolves anchor overshoot issues in mobile networks using FWA devices 105. For example, the overshoot detection system 115 may determine a list of base stations 110 for a coverage area and may identify FWA device identifiers located in the coverage area. The overshoot detection system 115 may create a list of FWA device identifiers that are not connected to nearest base stations 110, indicative of anchor overshoots, and may perform specific actions based on this list to optimize network connectivity and performance. The actions performed by the overshoot detection system may include adjusting antenna parameters (e.g., tilt, angle, or transmit power) of base stations 110, to ensure that FWA devices 105 connect to intended neighboring base stations 110 rather than distant base stations 110, as well as highlighting anchor overshoot occurrences on a map for visual representation. Thus, the overshoot detection system 115 may conserve computing resources, networking resources, and/or other resources that would have otherwise been consumed by handling anchor overshoot issues, causing network inefficiencies and connectivity issues due to anchor overshoot, causing a poor user experience for a user of an FWA device 105 due to anchor overshoot, identifying the occurrences of anchor overshoots, rectifying and verifying resolutions of such occurrences, and/or the like.

As indicated above, FIGS. 1A-1I are provided as an example. Other examples may differ from what is described with regard to FIGS. 1A-1I. The number and arrangement of devices shown in FIGS. 1A-1I are provided as an example. In practice, there may be additional devices, fewer devices, different devices, or differently arranged devices than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) shown in FIGS. 1A-1I may perform one or more functions described as being performed by another set of devices shown in FIGS. 1A-1I.

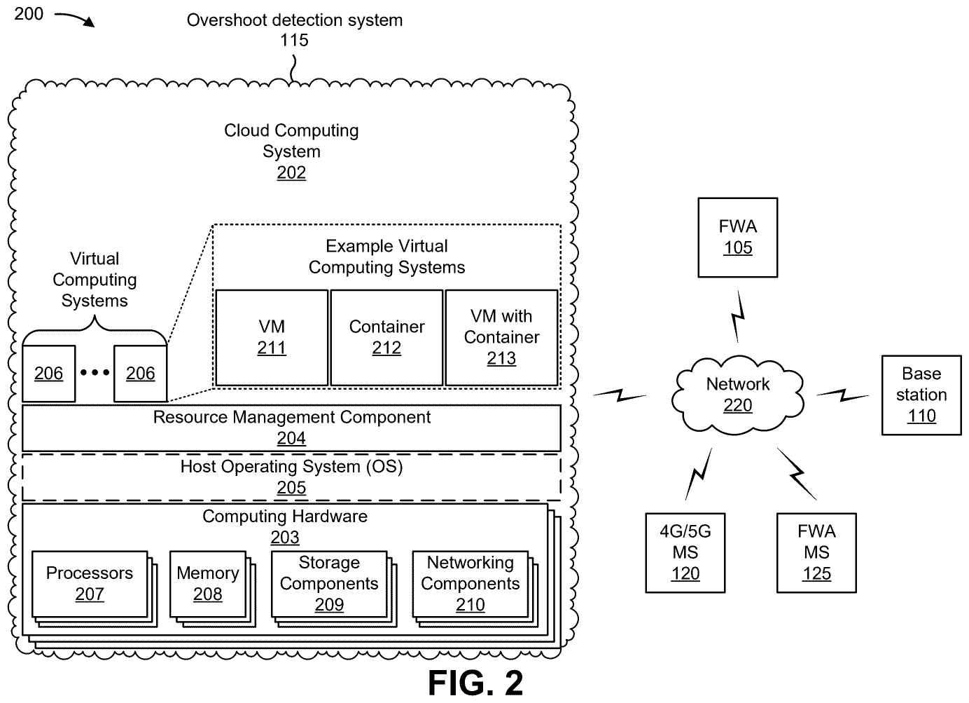

FIG. 2 is a diagram of an example environment 200 in which systems and/or methods described herein may be implemented. As shown in FIG. 2, the environment 200 may include the overshoot detection system 115, which may include one or more elements of and/or may execute within a cloud computing system 202. The cloud computing system 202 may include one or more elements 203-213, as described in more detail below. As further shown in FIG. 2, the environment 200 may include the FWA device 105, the base station 110, the 4G/5G MS 120, the FWA MS 125, and/or a network 220. Devices and/or elements of the environment 200 may interconnect via wired connections and/or wireless connections.

The FWA device 105 includes one or more devices capable of receiving, generating, storing, processing, and/or providing information, such as information described herein. For example, the FWA device 105 may include a mobile hotspot device, an FWA device, a customer premise equipment (CPE), an FWA channel service unit, an FWA data service unit, an FWA router, an FWA wireless access point (WAP) device, an FWA modem, an FWA set-top box, or a similar type of device. The UE may provide wireless connectivity through radio links between two fixed points. In other words, the UE may provide wireless Internet access to homes or businesses without laying fiber and cables to provide last mile connectivity.

The base station 110 includes one or more devices capable of transferring traffic, such as audio, video, text, and/or other traffic, destined for and/or received from a user equipment (UE). For example, the base station 110 may include an eNodeB (eNB) associated with a long term evolution (LTE) network that receives traffic from and/or sends traffic to a core network, a gNodeB (gNB) associated with a RAN of a 5G network, a base transceiver station, a radio base station, a base station subsystem, a cellular site, a cellular tower, an access point, a transmit receive point (TRP), a radio access node, a macrocell base station, a microcell base station, a picocell base station, a femtocell base station, and/or another network entity capable of supporting wireless communication. The base station 110 may support, for example, a cellular radio access technology (RAT). The base station 110 may transfer traffic between a UE (e.g., using a cellular RAT), one or more other base stations 110 (e.g., using a wireless interface or a backhaul interface, such as a wired backhaul interface), and/or a core network. The base station 110 may provide one or more cells that cover geographic areas.

The 4G/5G MS 120 may include one or more devices capable of receiving, generating, storing, processing, providing, and/or routing information, as described elsewhere herein. The 4G/5G MS 120 may include a communication device and/or a computing device. For example, the 4G/5G MS 120 may include a server, such as an application server, a client server, a web server, a database server, a host server, a proxy server, a virtual server (e.g., executing on computing hardware), or a server in a cloud computing system. In some implementations, the 4G/5G MS 120 may include computing hardware used in a cloud computing environment. In some implementations, the 4G/5G MS 120 may manage specific types of one or more network elements within a telecommunication network, such as one or more base stations 110.

The FWA MS 125 may include one or more devices capable of receiving, generating, storing, processing, providing, and/or routing information, as described elsewhere herein. The FWA MS 125 may include a communication device and/or a computing device. For example, the FWA MS 125 may include a server, such as an application server, a client server, a web server, a database server, a host server, a proxy server, a virtual server (e.g., executing on computing hardware), or a server in a cloud computing system. In some implementations, the FWA MS 125 may include computing hardware used in a cloud computing environment. In some implementations, the FWA MS 125 may manage specific types of one or more network elements within a telecommunication network, such as one or more FWA devices 105.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

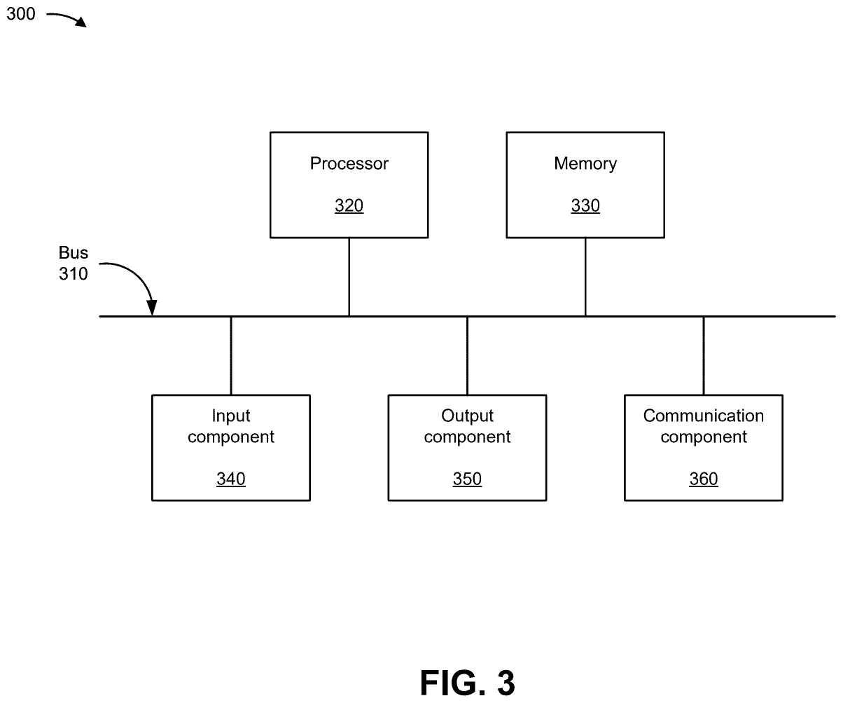

Although the overshoot detection system 115 may include one or more elements 203-213 of the cloud computing system 202, may execute within the cloud computing system 202, and/or may be hosted within the cloud computing system 202, in some implementations, the overshoot detection system 115 may not be cloud-based (e.g., may be implemented outside of a cloud computing system) or may be partially cloud-based. For example, the overshoot detection system 115 may include one or more devices that are not part of the cloud computing system 202, such as the device 300 of FIG. 3, which may include a standalone server or another type of computing device. The overshoot detection system 115 may perform one or more operations and/or processes described in more detail elsewhere herein.

The network 220 may include one or more wired and/or wireless networks. For example, the network 220 may include a cellular network (e.g., a 5G network, a 4G network, an LTE network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 220 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the FWA device 105, the base station 110, the overshoot detection system 115, the 4G/5G MS 120, and/or the FWA MS 125. In some implementations, the FWA device 105, the base station 110, the overshoot detection system 115, the 4G/5G MS 120, and/or the FWA MS 125 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

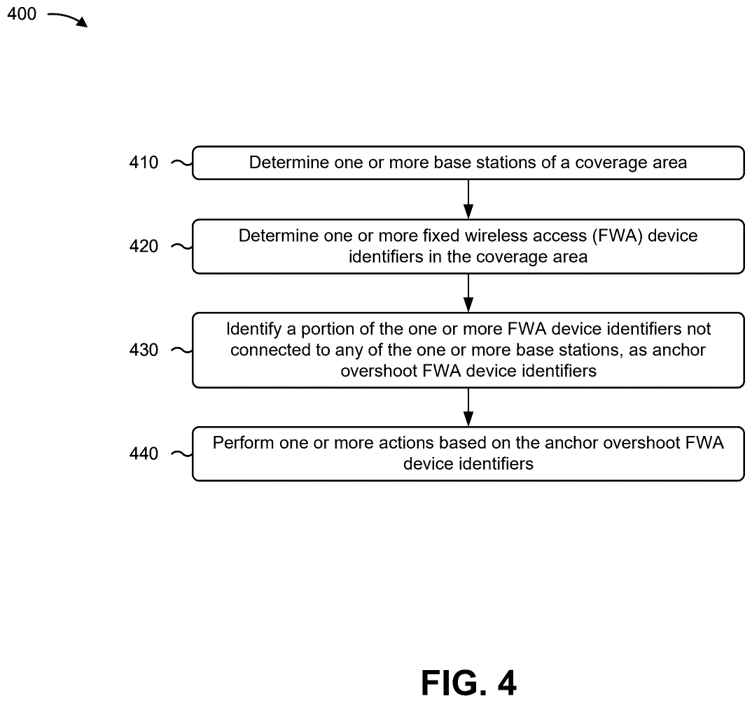

FIG. 4 is a flowchart of an example process 400 for detecting anchor overshoot for an FWA device. In some implementations, one or more process blocks of FIG. 4 may be performed by a device (e.g., the overshoot detection system 115). In some implementations, one or more process blocks of FIG. 4 may be performed by another device or a group of devices separate from or including the device, such as an FWA device (e.g., the FWA device 105) and/or a base station (e.g., the base station 110). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include determining one or more base stations of a coverage area (block 410). For example, the device may determine one or more base stations of a coverage area, as described above. In some implementations, the one or more base stations are associated with locations and signal quality indicators. In some implementations, the signal quality indicators include one or more of a reference signal received power, a reference signal received quality, a channel quality indicator, or a signal-to-interference-plus-noise ratio.

As further shown in FIG. 4, process 400 may include determining one or more FWA device identifiers in the coverage area (block 420). For example, the device may determine one or more FWA device identifiers in the coverage area, as described above. In some implementations, the FWA device identifiers include MDNs of FWA devices in the coverage area.

As further shown in FIG. 4, process 400 may include identifying a portion of the one or more FWA device identifiers not connected to any of the one or more base stations, as anchor overshoot FWA device identifiers (block 430). For example, the device may identify a portion of the one or more FWA device identifiers not connected to any of the one or more base stations, as anchor overshoot FWA device identifiers, as described above.

As further shown in FIG. 4, process 400 may include performing one or more actions based on the anchor overshoot FWA device identifiers (block 440). For example, the device may perform one or more actions based on the anchor overshoot FWA device identifiers, as described above. In some implementations, performing the one or more actions includes excluding the anchor overshoot FWA device identifiers from a list of the one or more FWA device identifiers. In some implementations, performing the one or more actions includes highlighting the anchor overshoot FWA device identifiers on a map, and providing the map for display.

In some implementations, performing the one or more actions includes determining signal information of connected base stations and neighboring base stations associated with the anchor overshoot FWA device identifiers, and causing the signal information of the connected base stations and the neighboring base stations to be modified to prevent FWA devices associated with the anchor overshoot FWA device identifiers from experiencing anchor overshoot. In some implementations, performing the one or more actions includes identifying a connected base station and a neighboring base station associated with one of the anchor overshoot FWA device identifiers, and modifying at least one parameter of the connected base station or the neighboring base station to prevent anchor overshoot of an FWA device associated with the one of the anchor overshoot FWA device identifiers.

In some implementations, performing the one or more actions includes identifying a connected base station and a neighboring base station associated with one of the anchor overshoot FWA device identifiers, and causing one or more antennas of the connected base station or the neighboring base station to be adjusted to prevent anchor overshoot of an FWA device associated with the one of the anchor overshoot FWA device identifiers. In some implementations, performing the one or more actions includes identifying a connected base station and a neighboring base station associated with one of the anchor overshoot FWA device identifiers, and causing one or more antenna tilt angles of the connected base station or the neighboring base station to be adjusted to prevent anchor overshoot of an FWA device associated with the one of the anchor overshoot FWA device identifiers.

In some implementations, performing the one or more actions includes identifying a connected base station and a neighboring base station associated with one of the anchor overshoot FWA device identifiers, and causing transmit power levels of the connected base station or the neighboring base station to be adjusted to prevent anchor overshoot of an FWA device associated with the one of the anchor overshoot FWA device identifiers. In some implementations, performing the one or more actions includes providing the anchor overshoot FWA device identifiers for display.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

In some implementations, process 400 includes prioritizing the one or more actions based on a volume of traffic in the coverage area and a quantity of FWA devices associated with the anchor overshoot FWA device identifiers.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
determining, by a device, one or more base stations of a coverage area;
determining, by the device, one or more fixed wireless access (FWA) device identifiers in the coverage area;
identifying a portion of the one or more FWA device identifiers not connected to any of the one or more base stations, as anchor overshoot FWA device identifiers; and
performing, by the device, one or more actions based on the anchor overshoot FWA device identifiers.

2. The method of claim 1, wherein performing the one or more actions comprises:
excluding the anchor overshoot FWA device identifiers from a list of the one or more FWA device identifiers.

3. The method of claim 1, wherein performing the one or more actions comprises:
highlighting the anchor overshoot FWA device identifiers on a map; and
providing the map for display.

4. The method of claim 1, wherein performing the one or more actions comprises:
determining signal information of connected base stations and neighboring base stations associated with the anchor overshoot FWA device identifiers; and
causing the signal information of the connected base stations and the neighboring base stations to be modified to prevent FWA devices associated with the anchor overshoot FWA device identifiers from experiencing anchor overshoot.

5. The method of claim 1, wherein performing the one or more actions comprises:
identifying a connected base station and a neighboring base station associated with one of the anchor overshoot FWA device identifiers; and
modifying at least one parameter of the connected base station or the neighboring base station to prevent anchor overshoot of an FWA device associated with the one of the anchor overshoot FWA device identifiers.

6. The method of claim 1, wherein the one or more base stations are associated with locations and signal quality indicators.

7. The method of claim 6, wherein the signal quality indicators include one or more of a reference signal received power, a reference signal received quality, a channel quality indicator, or a signal-to-interference-plus-noise ratio.

8. A device, comprising:
one or more processors configured to:
determine a first list of base stations of a coverage area,
wherein the first list of the base stations includes data identifying locations of the base stations and signal quality indicators associated with the base station;
determine a second list of fixed wireless access (FWA) device identifiers in the coverage area;
create a third list of anchor overshoot FWA device identifiers based on the FWA device identifiers in the second list that are not connected to one of the base stations in the first list; and
perform one or more actions based on the third list of anchor overshoot FWA device identifiers.

9. The device of claim 8, wherein the FWA device identifiers include mobile directory numbers of FWA devices in the coverage area.

10. The device of claim 8, wherein the one or more processors, to perform the one or more actions, are configured to:
identify a connected base station and a neighboring base station associated with one of the anchor overshoot FWA device identifiers; and
cause one or more antennas of the connected base station or the neighboring base station to be adjusted to prevent anchor overshoot of an FWA device associated with the one of the anchor overshoot FWA device identifiers.

11. The device of claim 8, wherein the one or more processors are further configured to:
prioritize the one or more actions based on a volume of traffic in the coverage area and a quantity of FWA devices associated with the anchor overshoot FWA device identifiers.

12. The device of claim 8, wherein the one or more processors, to perform the one or more actions, are configured to:
identify a connected base station and a neighboring base station associated with one of the anchor overshoot FWA device identifiers; and
cause one or more antenna tilt angles of the connected base station or the neighboring base station to be adjusted to prevent anchor overshoot of an FWA device associated with the one of the anchor overshoot FWA device identifiers.

13. The device of claim 8, wherein the one or more processors, to perform the one or more actions, are configured to:
identify a connected base station and a neighboring base station associated with one of the anchor overshoot FWA device identifiers; and
cause transmit power levels of the connected base station or the neighboring base station to be adjusted to prevent anchor overshoot of an FWA device associated with the one of the anchor overshoot FWA device identifiers.

14. The device of claim 8, wherein the one or more processors, to perform the one or more actions, are configured to:
provide the anchor overshoot FWA device identifiers for display.

15. A non-transitory computer-readable medium storing a set of instructions, the set of instructions comprising:
one or more instructions that, when executed by one or more processors of a device, cause the device to:
determine a first list of base stations of a coverage area;
determine a second list of fixed wireless access (FWA) device identifiers in the coverage area,
wherein the FWA device identifiers include mobile directory numbers of FWA devices in the coverage area;
create a third list of anchor overshoot FWA device identifiers based on the FWA device identifiers in the second list that are not connected to one of the base stations in the first list; and
perform one or more actions based on the third list of anchor overshoot FWA device identifiers.

16. The non-transitory computer-readable medium of claim 15, wherein the one or more instructions, that cause the device to perform the one or more actions, cause the device to:
highlight the anchor overshoot FWA device identifiers of the third list on a map; and
provide the map for display.

17. The non-transitory computer-readable medium of claim 15, wherein the one or more instructions, that cause the device to perform the one or more actions, cause the device to:
determine signal information of connected base stations and neighboring base stations associated with the anchor overshoot FWA device identifiers; and
cause the signal information of the connected base stations and the neighboring base stations to be modified to prevent the FWA devices associated with the anchor overshoot FWA device identifiers from experiencing anchor overshoot.

18. The non-transitory computer-readable medium of claim 15, wherein the one or more instructions, that cause the device to perform the one or more actions, cause the device to:
identify a connected base station and a neighboring base station associated with one of the anchor overshoot FWA device identifiers; and
modify at least one parameter of the connected base station or the neighboring base station to prevent anchor overshoot of one of the FWA devices associated with the one of the anchor overshoot FWA device identifiers.

19. The non-transitory computer-readable medium of claim 15, wherein the one or more instructions, that cause the device to perform the one or more actions, cause the device to:
identify a connected base station and a neighboring base station associated with one of the anchor overshoot FWA device identifiers; and
cause one or more antennas of the connected base station or the neighboring base station to be adjusted to prevent anchor overshoot of one of the FWA devices associated with the one of the anchor overshoot FWA device identifiers.

20. The non-transitory computer-readable medium of claim 15, wherein the one or more instructions further cause the device to:
prioritize the one or more actions based on a volume of traffic in the coverage area and a quantity of the FWA devices associated with the anchor overshoot FWA device identifiers.
